(19) United States
(12) Patent Application Publication
(10) Pub. No.: US 2020/0202074 A1
(43) Pub. Date: Jun. 25, 2020

(54) SEMSANTIC PARSING

(71) Applicant: Factmata Limited, London (GB)

(72) Inventor: Dhruv Ghulati, London (GB)

(21) Appl. No.: 16/643,571

(22) PCT Filed: Aug. 29, 2018
(86) PCT No.: PCT/GB2018/052439

§ 371 Date: Mar. 1, 2020

Related U.S. Application Data
(60) Provisional application No. 62/551,559, filed on Aug. 29, 2017.

(30) Foreign Application Priority Data
Aug. 29, 2017 (GB) 1713820.7

(51) Int. Cl. G06F 40/30; G06F 16/33; G06F 40/205

(52) U.S. Cl. CPC G06F 40/30; G06F 40/205; G06F 16/3344

(57) ABSTRACT

The present invention relates to a system and method for verification scoring and automated fact checking. More particularly, the present invention relates to assisted fact checking techniques which can also be used to create training data for a system to automatically verify facts/statements. According to a first aspect, there is a method of verifying content by performing semantic parsing, the method comprising the steps of: receiving one or more pieces of content; performing semantic parsing on the one or more pieces of content; identifying one or more semantic components as textual and/or numerical claims to be verified; obtaining one or more databases comprising information corresponding to the textual and/or numerical claims to be verified; generating a logical form for the textual and/or numerical claims whereby the logical form relates to a corresponding query of the one or more databases; and providing a verification output in dependence upon comparing data from the one or more databases.

### CROSS-REFERENCE TO RELATED APPLICATIONS

This Application is a U.S. Patent Application claiming the benefit of PCT International Application No. PCT/GB2018/052439, filed on 29 AUG. 2018, which claims the benefit of U.K. Provisional Application No. 1713820.7, filed on 29 AUG. 2017, and U.S. Provisional Application No. 62/551,559, filed on 29 AUG. 2017, all of which are incorporated in their entireties by this reference.

### TECHNICAL FIELD

The present invention relates to a system and method for verification scoring and automated fact checking. More particularly, the present invention relates to assisted fact checking techniques which can also be used to create training data for a system to automatically verify facts/statements.

### BACKGROUND

Owing to the increasing usage of the internet, and the ease of generating content on micro-blogging and social networks like Twitter and Facebook, articles and snippets of text are created on a daily basis at an ever-increasing rate. However, unlike more traditional publishing platforms like digital newspapers, micro-blogging platforms and other online publishing platforms allow a user to publicise their statements without a proper editorial or fact-checking process in place.

Writers on these platforms may not have expert knowledge or research the facts behind what they write, and currently there is no obligation to do so. Content is incentivised by catchiness and that which may earn most advertising click-throughs, rather than quality and informativeness. Therefore, a large amount of content which internet users are exposed to may be at least partially false or exaggerated, but still shared as though it were true.

Currently, the only way of verifying articles and statements made online is by having experts in the field of the subject matter either approve content once it is published or before it is published. This requires a significant number of reliable expert moderators to be on hand and approving content continuously, which is not feasible.

Existing methods/systems for automatically verifying content usually struggle in complex situations where there are a number of variables in question.

Additionally, existing methods/systems for verifying content which are not automated are unscalable, costly, and very labour-intensive.

### SUMMARY OF THE INVENTION

Aspects and/or embodiments seek to provide a method of verifying content by implementing semantic parsing techniques and assisted fact checking techniques. Aspects and/or embodiments also seek to provide a method of creating training data for an automated content verification system.

According to a first aspect, there is a method of verifying content by performing semantic parsing, the method comprising the steps of: receiving one or more pieces of content; performing semantic parsing on the one or more pieces of content; identifying one or more semantic components as textual and/or numerical claims to be verified; obtaining one or more databases comprising information corresponding to the textual and/or numerical claims to be verified; generating a logical form for the textual and/or numerical claims whereby the logical form relates to a corresponding query of the one or more databases; and providing a verification output in dependence upon comparing data from the one or more databases.

Any article, statement and comment can contain a number of claims, or facts, which may need to be verified. Since quantitative statements are generally easier to verify compared to qualitative statements, semantic parsing is used to break up the incoming article/statement/comment and identify the quantitative components. Once the quantitative components are identified, reference databases/information can be obtained and used to verify the incoming content. Since there may be more than one quantitative component of the incoming content, a number of different databases may need to be queried in order to verify the content. The relationship between each, or any, database used is convincedly represented in a logical form format.

Optionally, the one or more pieces of content comprises user generated content and/or user selected content and/or automatically detected content. Optionally, the one or more pieces of content comprises one or more variables. In this way, the incoming or received content may be something that is automatically detected, or a user specifically wants to verify a particular article/statement/comment.

Optionally, the one or more pieces of content comprises a combination of textual and/or numerical information, one or more claims and/or one or more statements. Textual information may refer to qualitative content and numerical information may refer to quantitative content.

Optionally, the one or more databases further comprises factual and/or verified reference information. Optionally, the one or more databases further comprises a table of information comprising one or more rows and columns. In this way, the reference information provided by each database may be in the format of a look up table providing quantitative facts for a specific subject matter, and each quantitative component of an incoming piece of content may relate to a different subject.

Optionally, the logical form comprises an algebraic relationship between the one or more rows and columns of the one or more database tables. Optionally, the logical form comprises a ratio between the one or more databases.

Optionally, the logic form is generated based upon user inputs via a user interface. Optionally, the logical form is generated based on one or more user selections connecting the cells of one or more databases. Optionally, the one or more user selections comprises one or more mathematical operators.

In the case of a human fact-checker verifying content, the fact-checker may select relevant information from one look up table and cross reference it with relevant information from another look up table. The logic equation may be generated based on the selections made by the fact-checker.

Optionally, the one or more selections are annotated and/or justified by the user or fact-checker. In this way, at each step of the process, the fact-checker can be questioned over the selection made and describe why a particular selection was made.

Optionally, the logical form generated based on user inputs is used as training data. As human fact-checkers work through verifying incoming content, each verification will generate a mathematical logic equation which can be used to automate content verification.

Optionally, the logical form is generated automatically using the training data. This can be used as training data for new input data, using the training data gathered from the human annotation process.

Optionally, the logical form is generated using a combination of manual user inputs and the training data. In this way, the method of content verification becomes a semi-automated process, whereby part of the process is carried out automatically and the other part of the verification process is expert assisted.

According to a second aspect, there is a method of creating training data for an automated content verification system for user generated content, the method comprising the steps of; receiving one or more user generated content; performing semantic parsing on the one or more user generated content; identifying one or more semantic components as textual and/or numerical claims to be verified; having a user obtain one or more databases comprising information corresponding to the textual and/or numerical claims to be verified; and manually and/or semi-automatically generating a logical form as training data wherein the logical form relates to a corresponding query of the one or more databases.

In this way, a set of training data may be created based on the workings of an expert fact checker whilst s/he is verifying a certain article/statement/comment. The workings of the expert are represented in by a mathematical logic equation which may be used to automate content verification.

According to third aspect, there is provided an apparatus operable to perform the method of any preceding feature.

According to fourth aspect, there is provided a system operable to perform the method of any preceding feature.

According to fifth aspect, there is provided a computer program operable to perform the method and/or apparatus and/or system of any preceding feature.

### BRIEF DESCRIPTION OF THE DRAWINGS

Embodiments will now be described, by way of example only and with reference to the accompanying drawings having like-reference numerals, in which:

FIG. 1 illustrates an example of a semantic parsing system and method;

FIG. 2 illustrates a second example of a semantic parsing system and method;

FIG. 3 illustrates how a semantic parsing system and method may be used in an automated content verification system; and

FIG. illustrates a fact checking system.

### SPECIFIC DESCRIPTION

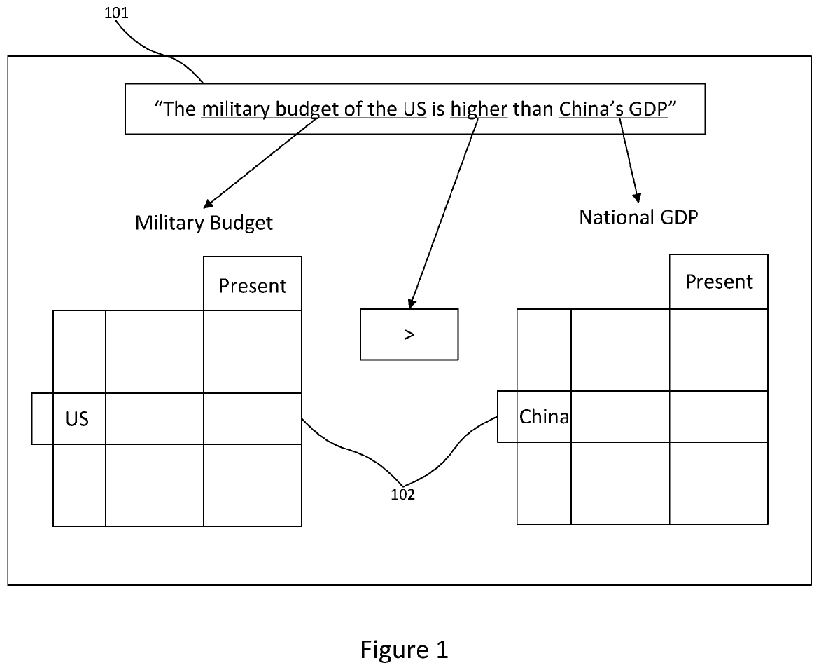

Embodiments of the semantic parsing system and method will now be described with the assistance of FIGS. 1 to 4.

Sentences/articles/comments often include a combination of textual information and numerical information. In order for a computer to map a natural language sentence into a formal representation and identify the different textual and numerical components, semantic parsing is performed.

Once the textual and numerical components have been identified, the textual components may be used to label or assign a topic/field/subject matter for numerical components. Once this is achieved, a quantitative (numerical) claim and/or statement made in a sentence, article, and/or comment may be verified by comparing it to factual and/or reference information for that particular topic. Such factual and/or reference information may be part of a reference table and/or a table stored in a database.

In order to verify and/or fact-check numerical statements accurately and automatically, the factual and/or reference information to compare the claim and/or statement against may require querying and interrogating several different reference tables and/or databases. It is often unlikely that reference information relevant to the claims and/or statements may be found just a single data source, which may be a reference table, a data point, a table within a database, or a database.

Given that it is likely that more than one data source must be interrogated to verify claims and/or statements properly, the present semantic parsing system and method generates a logical form for each claim/statement that represents the required database queries. More specifically, this logical form indicates how the components of the claim and/or statement relate to the at least one data source.

A semantic parsing system and method for fact-checking is described herein, which may enable human experts can help to verify complex claims and/or statements and produce a logical form which may query the correct data source in a way that the human expert may have, in order to verify the claim and/or statement. Semantic parsing focuses on mapping natural language to machine readable representations. There may be various ways the mapping process may be implemented, for example, relying on high-quality lexicons, manually or semi-automatically built templates, and linguistic features which may be domain or representation specific or there may be a system which encodes and decodes utterances in order to generate their logical forms. In embodiments, once a logical form is produced, a

querying stage is carried out which may be a SQL query of databases. The implementation of the SQL query stage will be of knowledge to a person skilled in the art.

### EXAMPLE 1

Sentence to be verified:

“The Unemployment rate of the UK was 4% in 2004”

In this example, it can be seen that the topic is “unemployment rates in the UK” and the claim or statement that requires verification is whether or not the unemployment rate was in fact “4% in 2004”.

An automated fact-checking system may refer easily to a data source which contains information about unemployment rates in the UK for the year 2004. The automated system may compare the number claimed in the sentence (4%) against the actual recorded employment rate in 2004 which is stored in a data source, thereby verifying the sentence as either true or false.

However, it is more complex for automated fact-checking systems or methods to verify sentences sufficiently which contain a more than one variable. Such sentences may be referred to as complex claims.

The following examples of complex claims will be used to further illustrate the workings of the present semantic parsing system and method.

### EXAMPLE 2

Sentence to be verified, as shown in FIG. 1, 101:

“The US has a larger military budget than China's national GDP”

In this case, data sources 102 may be identified which includes information about the US military budget and which includes information about China's GDP in order to make the comparison. As this is a complex claim and requires an expert to verify the claims and/or statements against information which relates to two different areas of subject matter, the reference information for the two topics may be presented in a format in which the expert may highlight, annotate and/or justify the selections made.

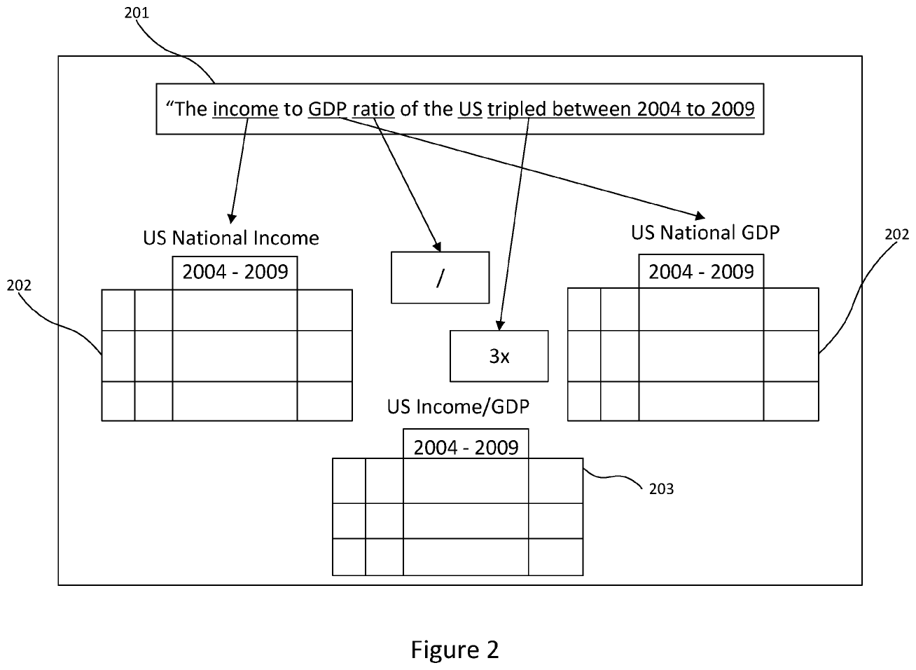

The expert may be asked to highlight the relevant data and connect the data sources together using “algebraic connectors” to form the diagram depicted in FIG. 2. This enables a powerful logical form for the statement and/or claim to be generated, and this may represent the workings of the expert.

As an example of the logical form, the output for this example could be:

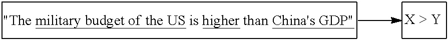

### EXAMPLE 3

Sentence to be verified, as shown in FIG. 2, 201 :

“The income to GDP ratio of the US tripled between 2004 to 2009”

Rather than the comparison of data sources set out in example 2, this example relates to the manipulation of information from data sources. Particularly, in this case, income to GDP ratio 203 may not be a data point (or range of data) generally stored within a data source. Therefore, in order to verify this claim, the information required for verification must be generated by manipulating data from at least one of the data sources 202. In this example, the data required includes information about income and GDP, over a number of years. This data may then be used to determine the ratios which must be verified.

As depicted in FIG. 2, each component of the sentence corresponds to a reference table containing factual reference information.

For this sentence/claim, the method sources the relevant data source which contains information about US National income and US National GDP between 2004 and 2009. With these tables, the expert fact-checker may make connections using mathematical operators (division in this case) to divide the data in the data source to calculate a ratio. The expert may then compare the ratios (again using division) to establish whether the output of the logical form is approximately ‘3’.

As an example of the logical form, the output for this example could be:

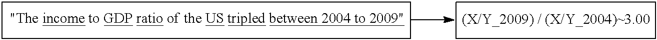

Embodiments of the system and method described herein can allow artificial intelligence/machine learning and/or computer systems to recognise and process complex claims and/or statements, to source appropriate data sources, and carry out the correct calculations. As an example, this can be very important for automated political fact checking.

Embodiments of the system and method described herein can fact check across different realms or domains of information. By way of an example, a financial auditor or financial journalist may wish to combine information which relates to different subject matters, and could employ the system and method described herein in order to create interfaces and/or generate logical forms in order to calculate data relationships. A financial auditor checking claims and/or statements and carrying out calculations on financial statements or market data may use the system and method described herein to carry out complex operations on datasets automatically, without user input from manipulating rows on a spreadsheet. Further, a voice-driven interface may also use such a training data generation mechanism.

The system and method described herein may also allow an expert fact-checker a full range of flexibility when needing to verify claims and/or statements against data sources containing reference information. By way of an example, the fact-checker may divide, add, subtract, and perform any other arithmetic calculation using the data sources as a whole, in part, or more specifically with particular data points from each source.

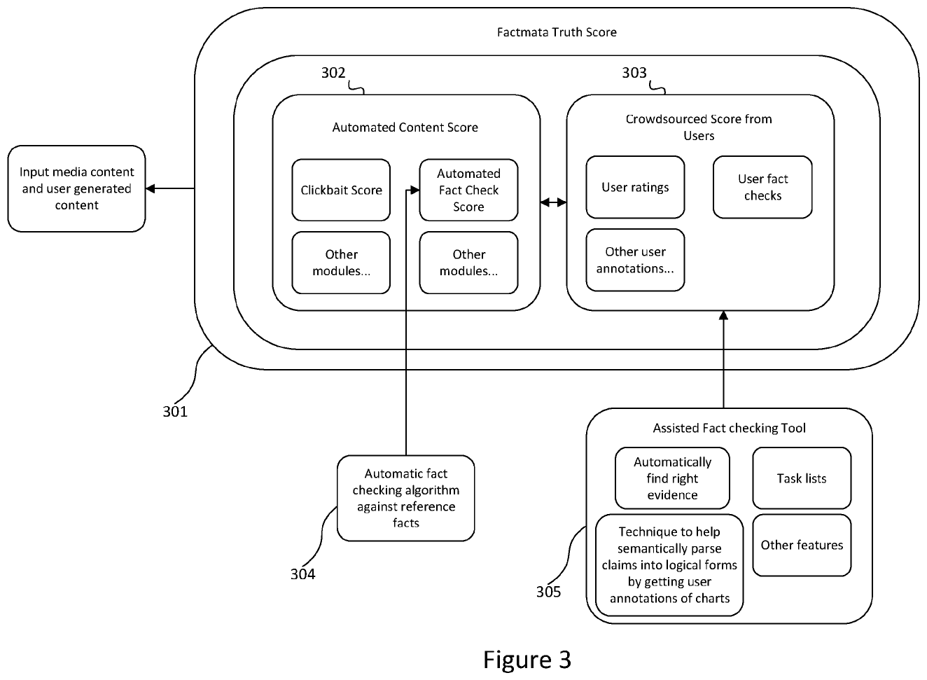

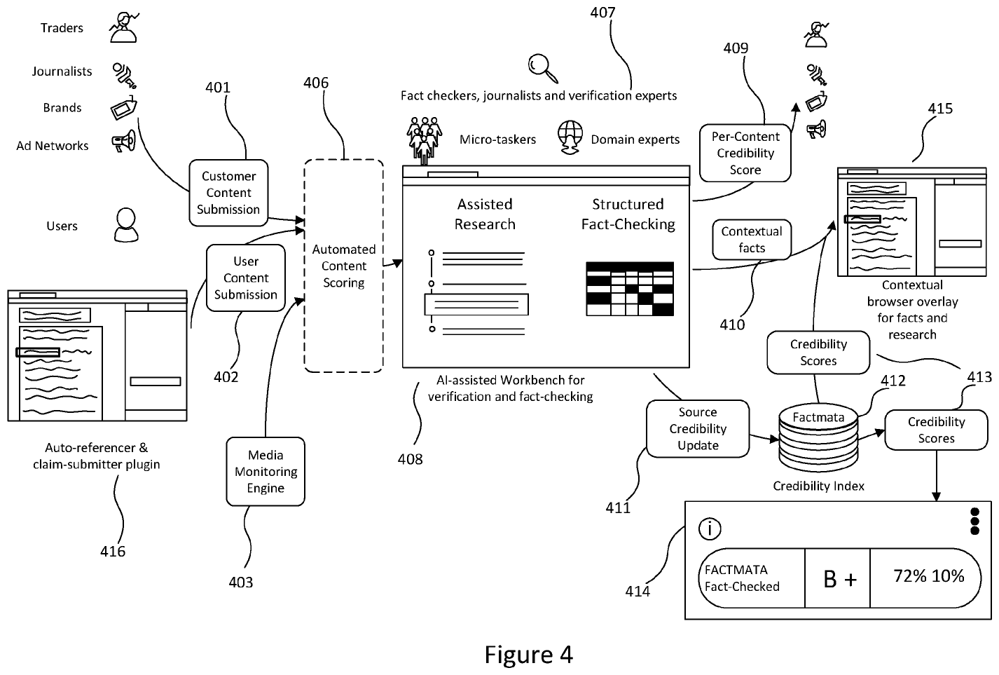

Importantly, any logical form generated may be used as training for an automated content verification system. FIG. 3 depicts how the system and method described herein may form an integral component of an overall truth score generating system.

FIG. 3 illustrates a flowchart of truth score generation 301 including both manual and automated scoring. A combination of an automated content score 302 and a crowdsourced score 303 i.e. content scores determined by users such as expert annotators, may include a clickbait score module, an automated fact checking scoring module, other automated modules, user rating annotations, user fact checking annotations and other user annotations. In an example embodiment, the automated fact checking scoring module comprises an automatic fact checking algorithm 304 provided against reference facts. Also, users may be provided with an assisted fact checking tool/platform 305. Such tool/platform may assist a user(s) in automatically finding correct evidence, a task list, techniques to help semantically parse claims into logical forms by getting user annotations of charts for example as well as other extensive features.

FIG. 4 depicts an “Automated Content Scoring” module 406 which produces a filtered and scored input for a network of fact checkers. Input into the automated content scoring module 406 may include customer content submissions 401 from traders, journalists, brands, ad networks user etc., user content submissions 402 from auto-reference and claim-submitter plugins 416 and content identified by a media monitoring engine 403. The content moderation network of fact checkers 407 including fact checkers, journalists, verification experts, grouped as micro taskers and domain experts, then proceeds by verifying the content as being misleading and fake through an Al-assisted workbench 408 for verification and fact-checking. The other benefit of such a system is that it provides users with an open, agreeable quality score for content. For example, it can be particularly useful for news aggregators who want to ensure they are only showing quality content but together with an explanation. Such a system may be combined with or implemented in conjunction with a quality score module or system.

This part of the system may be an integrated development environment or browser extension for human expert fact checkers to verify potentially misleading content. This part of the system is particularly useful for claims/statements that are not instantly verifiable, for example if there are no public databases to check against or the answer is too nuanced to be provided by a machine. These fact checkers, as experts in various domains, have to carry out a rigorous onboarding process, and develop reputation points for effectively moderating content and providing well thought out fact checks. The onboarding process may involve, for example, a standard questionnaire and/or based on profile assessment and/or previous manual fact checks made by the profile.

Through the Al-assisted workbench for verification and fact-checking 408, a per-content credibility score 409, contextual facts 410 and source credibility update 41 1 may be provided. The source credibility update may update the database 412 which generates an updated credibility score 413 and thus providing a credibility index as shown as 414 in FIG. 4. Contextual facts provided by the Al-assisted user workbench 408 and credibility scores 413 may be further provided as a contextual browser overlay for facts and research 415.

The assisted fact checking tools have key components that effectively make it a code editor for fact checking, as well as a system to build a dataset of machine readable fact checks, in a very structured fashion. This dataset will allow a machine to fact check content automatically in various domains by learning how a human being constructs a fact check, starting from a counter-hypothesis and counter-argument, an intermediate decision, a step by step reasoning, and a conclusion. Because the system can also cluster claims with different phrasings or terminology, it allows for scalability of the system as the claims are based online (global) and not based on what website the user is on, or which website the input data/claim is from. This means that across the internet, if one claim is debunked it does not have to be debunked again if it is found on another website.

In an embodiment, a user interface may be present wherein enabling visibility of labels and/or tags, which may be determined automatically or by means of manual input, to a user or a plurality of users/expert analysts. The user interface may form part of a web platform and/or a browser extension which provides users with the ability to manually label, tag and/or add description to content such as individual statements of an article and full articles.

As described above, the data sources used for verification need not be a database, but may be data stored in any suitable storage, which may include at least one semi-structured table or set of semi-structured tables, a spreadsheet, or any other suitable storage.

Optionally, all algorithms and method described above as embodiments or alternative or optional features of the embodiments/aspects may be provided as learned algorithms and/or method, e.g. by using machine learning techniques to learn the algorithm and/or method. Machine learning is the field of study where a computer or computers learn to perform classes of tasks using the feedback generated from the experience or data gathered that the machine learning process acquires during computer performance of those tasks.

Typically, machine learning can be broadly classed as supervised and unsupervised approaches, although there are particular approaches such as reinforcement learning and semi-supervised learning which have special rules, techniques and/or approaches. Supervised machine learning is concerned with a computer learning one or more rules or functions to map between example inputs and desired outputs as predetermined by an operator or programmer, usually where a data set containing the inputs is labelled.

Unsupervised learning is concerned with determining a structure for input data, for example when performing pattern recognition, and typically uses unlabelled data sets. Reinforcement learning is concerned with enabling a computer or computers to interact with a dynamic environment, for example when playing a game or driving a vehicle.

Various hybrids of these categories are possible, such as “semi-supervised” machine learning where a training data set has only been partially labelled. For unsupervised machine learning, there is a range of possible applications such as, for example, the application of computer vision techniques to image processing or video enhancement. Unsupervised machine learning is typically applied to solve problems where an unknown data structure might be present in the data. As the data is unlabelled, the machine learning process is required to operate to identify implicit relationships between the data for example by deriving a clustering metric based on internally derived information. For example, an unsupervised learning technique can be used to reduce the dimensionality of a data set and attempt to identify and model relationships between clusters in the data set, and can for example generate measures of cluster membership or identify hubs or nodes in or between clusters (for example using a technique referred to as weighted correlation network analysis, which can be applied to high-dimensional data sets, or using k-means clustering to cluster data by a measure of the Euclidean distance between each datum).

Semi-supervised learning is typically applied to solve problems where there is a partially labelled data set, for example where only a subset of the data is labelled. Semi- supervised machine learning makes use of externally provided labels and objective functions as well as any implicit data relationships. When initially configuring a machine learning system, particularly when using a supervised machine learning approach, the machine learning algorithm can be provided with some training data or a set of training examples, in which each example is typically a pair of an input signal/vector and a desired output value, label (or classification) or signal. The machine learning algorithm analyses the training data and produces a generalised function that can be used with unseen data sets to produce desired output values or signals for the unseen input vectors/signals. The user needs to decide what type of data is to be used as the training data, and to prepare a representative real-world set of data. The user must however take care to ensure that the training data contains enough information to accurately predict desired output values without providing too many features (which can result in too many dimensions being considered by the machine learning process during training, and could also mean that the machine learning process does not converge to good solutions for all or specific examples). The user must also determine the desired structure of the learned or generalised function, for example whether to use support vector machines or decision trees.

The use of unsupervised or semi-supervised machine learning approaches are sometimes used when labelled data is not readily available, or where the system generates new labelled data from unknown data given some initial seed labels.

Machine learning may be performed through the use of one or more of: a non-linear hierarchical algorithm; neural network; convolutional neural network; recurrent neural network; long short-term memory network; multi-dimensional convolutional network; a memory network; or a gated recurrent network allows a flexible approach when generating the predicted block of visual data. The use of an algorithm with a memory unit such as a long short-term memory network (LSTM), a memory network or a gated recurrent network can keep the state of the predicted blocks from motion compensation processes performed on the same original input frame. The use of these networks can improve computational efficiency and also improve temporal consistency in the motion compensation process across a number of frames, as the algorithm maintains some sort of state or memory of the changes in motion. This can additionally result in a reduction of error rates.

Any system features as described herein may also be provided as a method feature, and vice versa. As used herein, means plus function features may be expressed alternatively in terms of their corresponding structure.

Any feature described herein in connection with one aspect may be applied to other aspects, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects may be implemented and/or supplied and/or used independently.

1. A method of verifying content by performing semantic parsing, the method comprising the steps of:
receiving one or more pieces of content;
performing semantic parsing on the one or more pieces of content;
identifying one or more semantic components as textual and/or numerical claims to be verified;
obtaining one or more databases comprising information corresponding to the textual and/or numerical claims to be verified;
generating a logical form for the textual and/or numerical claims whereby the logical form relates to a corresponding query of the one or more databases; and
providing a verification output in dependence upon comparing data from the one or more databases.

2. The method of claim 1, wherein the one or more pieces of content comprises user generated content and/or user selected content and/or automatically detected content: optionally wherein the one or more pieces of content comprises one or more variables.

3. The method of claim 1, wherein the one or more pieces of content comprises a combination of textual and/or numerical information, one or more claims and/or one or more statements.

4. The method of claim 1, wherein the one or more databases further comprises factual and/or verified reference information.

5. The method of claim 1, wherein the one or more databases further comprises a table of information comprising one or more rows and columns.

6. The method of claim 5, wherein the logical form comprises algebraic relationship between the one or more rows and columns of the one or more databases:
optionally wherein the logical form comprises a ratio between the one or more databases.

7. The method of claim 1, wherein the logical form is generated based upon user inputs via a user interface.

8. The method of claim 7, wherein the logical form is generated based on one or more user selections connecting the one or more databases:
optionally wherein the one or more user selections comprises one or more mathematical operators.

9. The method of claim 8, wherein the one or more selections are annotated and/or justified by the user.

10. The method of claim 1, wherein the logical form generated based on user inputs is used as training data.

11. The method of claim 1, wherein the logical form is generated automatically using the training data.

12. The method of claim 11, wherein the logical form is generated using a combination of manual user inputs and the training data.

13. A method of creating training data for an automated content verification system for user generated content, the method comprising the steps of;
receiving one or more user generated content;
performing semantic parsing on the one or more user generated content;
identifying one or more semantic components as textual and/or numerical claims to be verified;
having a user obtain one or more databases comprising information corresponding to the textual and/or numerical claims to be verified; and
manually and/or semi-automatically generating a logical form as training data wherein the logical form relates to a corresponding query of the one or more databases.

14. The method of claim 13, further comprising the features of any of claims 2 to 12.

15. (canceled)

16. (canceled)

17. (canceled)
